(19) United States
(12) Patent Application Publication
(10) Pub. No.: US 2025/0268128 A1
(43) Pub. Date: Aug. 28, 2025

(54) MOWER DECK WITH SUSPENSION

(71) Applicant: FireFly Automatix, Inc., Salt Lake City, UT (US)

(72) Inventors: Mark C. LeBlanc, Salt Lake City, UT (US); Eric E. Aston, Farmington, UT (US)

(21) Appl. No.: 18/588,398

(22) Filed: Feb. 27, 2024

(51) Int. Cl. A01D 34/64; A01D 34/74; A01D 101/00

(52) U.S. Cl. CPC A01D 34/64; A01D 34/74; A01D 2101/00

(57) ABSTRACT

A mower deck can include a suspension that allows a rear roller to pivot rearwardly and upwardly when the rear roller encounters a bump in the ground. The suspension can include brackets having a front end that is coupled to a housing of the mower deck at a pivot point. The rear roller can be coupled between rear ends of the brackets. Springs can be used to bias the brackets into a maximum angle of less than 90 degrees to the horizontal.

### CROSS-REFERENCE TO RELATED APPLICATIONS

N/A

### BACKGROUND

Mower decks, particularly of industrial or commercial mowers, have front and rear rollers. For example, FIG. 1 shows a mower deck 10 having a housing 20 that is supported off the ground by a front roller 22 and a rear roller 23. Mower deck 10 includes a cutting unit in the form of a reel 21 but cutting unit(s) in the form of rotary blades are also oftentimes used.

### BRIEF SUMMARY

The present invention extends to a mower deck with suspension. The mower deck can include a rear roller but no front roller. The suspension can enable the rear roller to pivot as it passes over bumps or other uneven ground while maintaining a constant cutting height. As a result, a high spot will not be created after the bump due to pivoting of the mower deck.

In some embodiments, the present invention may be implemented as a mower deck that includes a housing that is supported off the ground by one or more rear rolling mechanisms, one or more cutting units housed within the housing, and a suspension by which each rear rolling mechanism is coupled to the housing. The suspension may include opposing brackets that are each connected to the housing at a pivot point and oriented rearwardly relative to the housing at a maximum angle less than 90 degrees from horizontal and opposing springs that bias the respective brackets into the maximum angle.

In some embodiments, the opposing springs may be configured to enable the opposing brackets to pivot rearwardly and upwardly to a reduced angle when the one or more rear rolling mechanisms encounter a bump.

In some embodiments, the one or more rear rolling mechanisms may be a rear roller.

In some embodiments, the pivot point may be towards front ends of the opposing brackets and the rear roller may be coupled between rear ends of the opposing brackets.

In some embodiments, the one or more rear rolling mechanisms may be opposing wheels.

In some embodiments, the pivot point may be towards front ends of the opposing brackets and each opposing wheel may be coupled to a rear end of the respective opposing bracket.

In some embodiments, the mower deck does not include a front rolling mechanism.

In some embodiments, the mower deck may include opposing stops that prevent the opposing brackets from pivoting beyond the maximum angle.

In some embodiments, the opposing springs may be one or more of a compression spring, a leaf spring, or a polymer insert.

In some embodiments, a spring rate of the opposing springs may be adjustable.

In some embodiments, the mower deck may include a support structure that supports the mower deck from a mower. The support structure may lock a pitch of the mower deck.

In some embodiments, the present invention may be implemented as a mower deck that includes a housing that is supported from a mower by a support structure, one or more cutting units housed within the housing, a rear roller, and a suspension by which the rear roller is coupled to the housing. The suspension may include opposing brackets that are each connected to the housing at a pivot point and oriented rearwardly relative to the housing at a maximum angle less than 90 degrees from horizontal and opposing springs that bias the respective brackets into the maximum angle.

In some embodiments, the mower deck may include stops that prevent the opposing brackets from pivoting beyond the maximum angle.

In some embodiments, the opposing springs may be configured to enable the opposing brackets to pivot rearwardly and upwardly to a reduced angle when the one or more rear rolling mechanisms encounter a bump.

In some embodiments, the maximum angle is between 35 and 70 degrees.

In some embodiments, the maximum angle is between 55 and 65 degrees.

In some embodiments, a spring rate of the opposing springs may be adjustable.

In some embodiments, the present invention may be implemented as a mower deck that includes a housing in which one or more cutting units are housed, a rear rolling mechanism that supports the housing above the ground, a bracket by which the rear rolling mechanism is coupled to the housing, the bracket being angled rearwardly relative to the housing at a maximum angle less than 90 degrees from horizontal, and a spring that biases the bracket into the maximum angle and allows the bracket to pivot to a reduced angle when the rear rolling mechanism encounters a bump in the ground.

In some embodiments, the rear rolling mechanism may be a rear roller, the bracket may be a first bracket that couples a first end of the rear roller to the housing, and the spring may be a first spring the biases the first bracket into the maximum angle. The mower deck may also include a second bracket that couples a second end of the rear roller to the housing, the second bracket being angled rearwardly relative to the housing at a maximum angle less than 90 degrees from horizontal and a second spring that biases the second bracket into the maximum angle and allows the second bracket to pivot to the reduced angle.

In some embodiments, a spring rate of the spring is adjustable.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a prior art mower deck that has front and rear rollers;

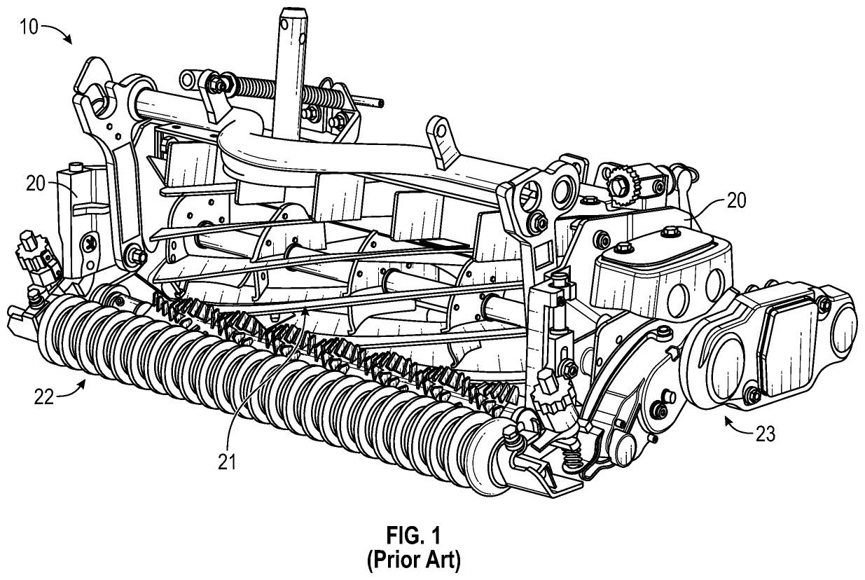

FIG. 2 provides an example of a mower deck that may include suspension in accordance with one or more embodiments of the present invention;

FIG. 3A is a cross-sectional view of a mower deck having rotary blades and suspension in accordance with one or more embodiments of the present invention;

FIG. 3B is a cross-sectional view of a mower deck having a reel and suspension in accordance with one or more embodiments of the present invention; and

FIGS. 4A-4D provide an example of how the suspension of a mower deck can maintain a constant cutting height when the mower deck passes over a bump.

### DETAILED DESCRIPTION

The suspension of the present invention can be used on a variety of mower decks including mower decks with different types of cutting units such as rotary blade(s) or a reel. A mower may include one or more mower decks with the suspension. For example, a large mower used to cut golf courses, stadiums, parks, sod farms, etc. could include multiple mower decks each of which includes the suspension of the present invention. As another example, a lawn mower may include a single mower deck having the suspension of the present invention.

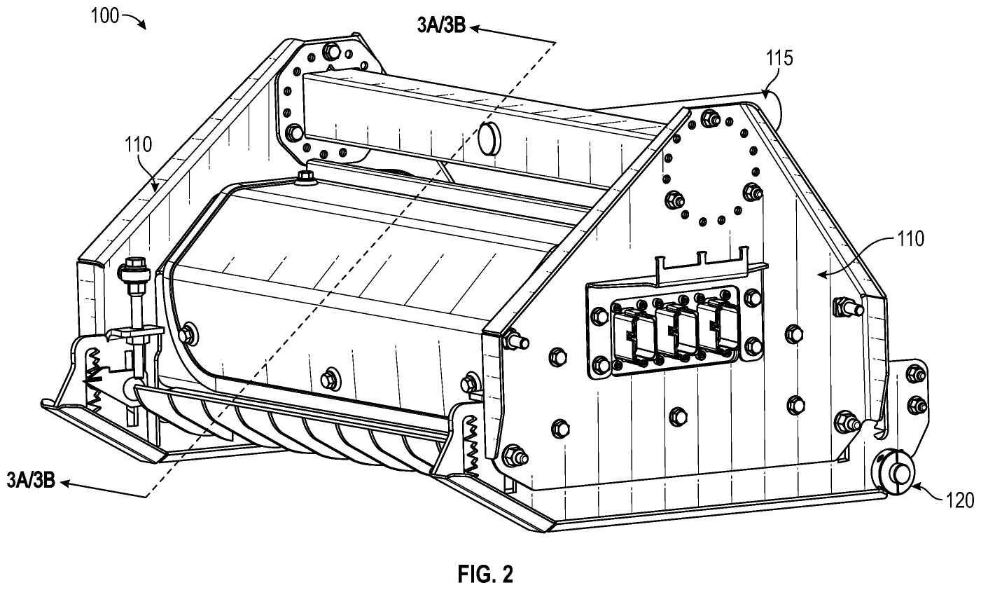

FIG. 2 provides an example of a mower deck 100 that may include suspension in accordance with embodiments of the present invention. Mower deck 100 includes a housing 110 that is supported from the mower (not shown) via a support structure 115. Support structure 115 is configured to lock the pitch of mower deck 100 so that the plane of mower deck 100 remains parallel to the ground. However, support structure 115 may allow mower deck 100 to roll. Mower deck 100 also includes a rear roller 120 but not a front roller. By eliminating the front roller, mower deck 100 will not flatten the grass before cutting it which is particularly beneficial when cutting longer grass.

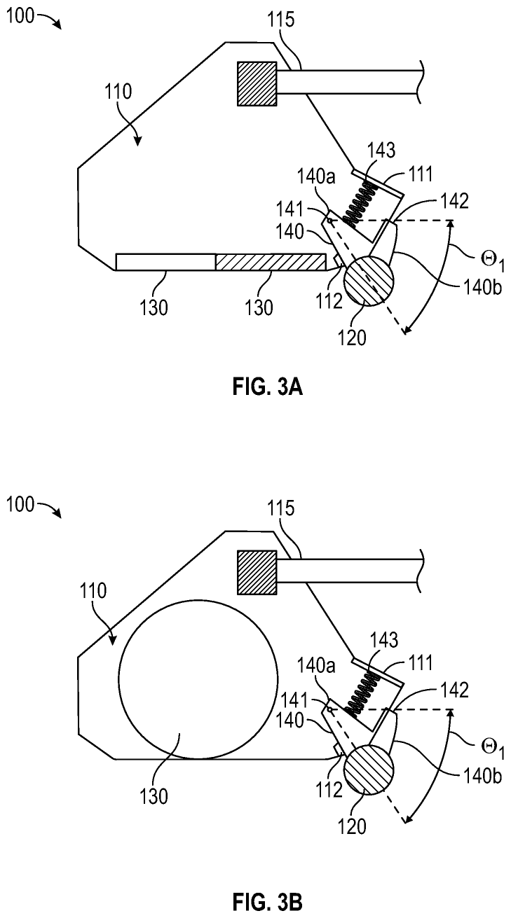

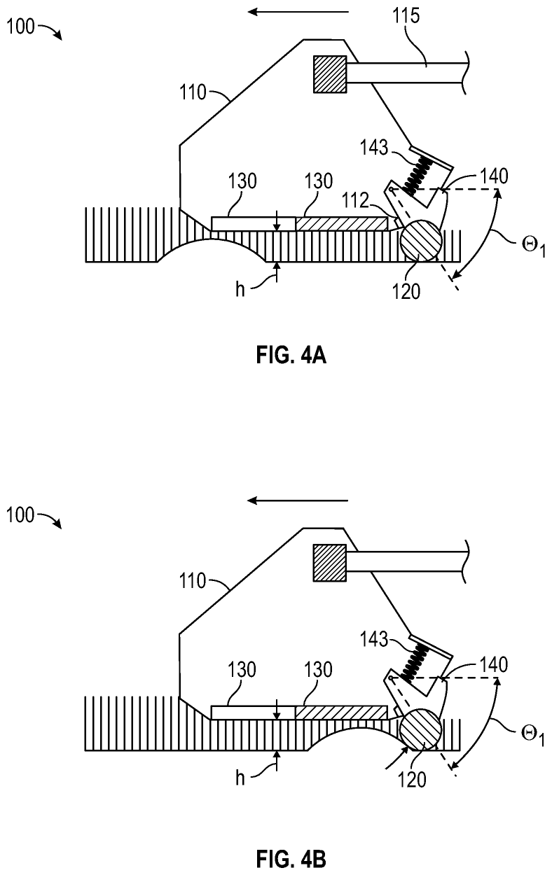

FIGS. 3A and 3B represent cross-sectional views of mower deck 100 when mower deck includes cutting unit(s) 130 in the form of rotary blades and a reel respectively and includes a suspension configured in accordance with embodiments of the present invention. In FIG. 3A, mower deck 100 includes three rotary blades, two frontward blades and a rearward blade positioned between the frontward blades.

As shown in both FIGS. 3A and 3B, a suspension configured in accordance with embodiments of the present invention may include opposing brackets 140 (only one is visible) having a front end 140a that is secured to housing 110 to form a pivot point 141 and a rear end 140b to which rear roller 120 is coupled. Each side of housing 110 may include a stop 112 that is positioned below the respective bracket 140 and defines the maximum angle (Θ₁) of bracket 140 relative to the horizontal (or the plane parallel to the ground). This maximum angle is less than 90° (i.e., bracket 140 is not vertical but angled rearwardly) and may typically be between 45° and 60°. A spring 143 can be positioned between bracket 140 and a portion 111 of housing 110 and can bias bracket 140 into this maximum angle. Bracket 140 may include an upward extension 142 at rear end 140b to cover spring 143. Spring 143 may be any suitable type of spring such as a compression spring, a leaf spring, a polymer insert, etc. In some embodiments, spring 143 may be adjustable to provide a desired spring rate for a particular application or conditions.

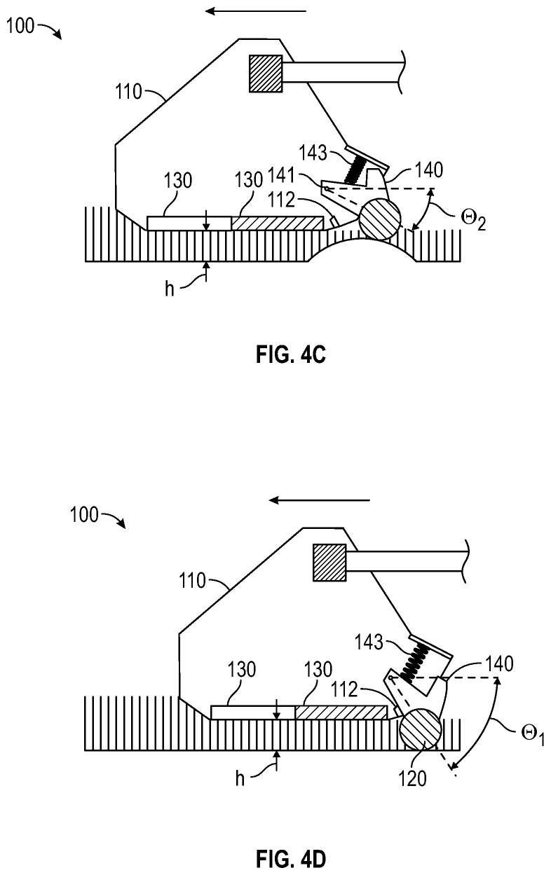

FIGS. 4A-4D provide an example of how this suspension can maintain the cutting height h of mower deck 100 when it passes over a bump. Turning to FIG. 4A, mower deck 100 is travelling from right to left and is approaching a bump in the soil. Spring 143 is maintaining bracket 140 against stop 112 and therefore at the maximum angle Θ₁. With bracket 140 at this maximum angle, rear roller 120 rests on the ground and defines the cutting height h. Due to support structure 115, mower deck 100 will be cantilevered with its pitch fixed.

Turning to FIG. 4B, the front of mower deck 100 has passed over the bump and rear roller 120 has reached the bump. Because there is no front roller, the bump does not impact mower deck 100 until this point. For example, there is no front roller that would cause mower deck 100 to pitch rearwardly as it climbs over the bump. As rear roller 120 reaches the bump, the bump will apply a rearwardly oriented force against rear roller 120 as represented by the arrow.

Turning to FIG. 4C, this rearwardly oriented force will cause bracket 140 to pivot rearwardly and upwardly around pivot point 141 to a reduced angle Θ₂ relative to the horizontal to thereby cause the cutting height h to remain substantially consistent as opposed to being temporarily elevated in front of the bump as rear roller 120 climbs the bump. This pivoting of bracket 140 compresses spring 143. While rear roller 120 passes over the rising edge of the bump, the rearwardly oriented force that the bump applied to rear roller 120 will cause bracket 140 to remain at or near this reduced angle Θ₂. As mentioned above, in some embodiments, the spring rate can be customized to control this reduced angle Θ₂. Then, as rear roller 120 passes over the top of the bump so that there is no longer a rearwardly oriented force against rear roller 120, spring 143 will cause bracket 140 to return towards the maximum angle Θ₁. This return to the maximum angle Θ₁ can coincide with the downslope of the bump such that the cutting height h remains substantially constant.

Finally, as represented in FIG. 4D, after passing over the bump, spring 143 has returned bracket 140 to the maximum angle Θ₁ where it may remain until encountering another bump. The spring rate of spring 143 may be selected to allow bracket 140 to pivot only when encountering a substantial bump or uneven surface so that bracket 140 remains at the maximum angle when rear roller 120 passes over typical variations in the ground.

Although embodiments of the present invention have been described in the context of a mower deck having a rear roller, a suspension configured in accordance with embodiments of the present invention could be used on a mower deck having rear wheels. For example, with reference to FIGS. 3A-4D, the depicted roller 120 could instead represent one of the rear wheels. Accordingly, embodiments of the present invention may be used in conjunction with different types of rolling mechanisms such as rollers and wheels.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A mower deck comprising:
a housing that is supported off the ground by one or more rear rolling mechanisms;
one or more cutting units housed within the housing; and
a suspension by which each rear rolling mechanism is coupled to the housing, the suspension comprising opposing brackets that are each connected to the housing at a pivot point and oriented rearwardly relative to the housing at a maximum angle less than 90 degrees from horizontal and opposing springs that bias the respective brackets into the maximum angle.

2. The mower deck of claim 1, wherein the opposing springs are configured to enable the opposing brackets to pivot rearwardly and upwardly to a reduced angle when the one or more rear rolling mechanisms encounter a bump.

3. The mower deck of claim 1, wherein the one or more rear rolling mechanisms are a rear roller.

4. The mower deck of claim 3, wherein the pivot point is towards front ends of the opposing brackets and the rear roller is coupled between rear ends of the opposing brackets.

5. The mower deck of claim 1, wherein the one or more rear rolling mechanisms comprise opposing wheels.

6. The mower deck of claim 5, wherein the pivot point is towards front ends of the opposing brackets and each opposing wheel is coupled to a rear end of the respective opposing bracket.

7. The mower deck of claim 1, wherein the mower deck does not include a front rolling mechanism.

8. The mower deck of claim 1, further comprising:
opposing stops that prevent the opposing brackets from pivoting beyond the maximum angle.

9. The mower deck of claim 1, wherein the opposing springs comprise one or more of a compression spring, a leaf spring, or a polymer insert.

10. The mower deck of claim 1, wherein a spring rate of the opposing springs is adjustable.

11. The mower deck of claim 1, further comprising:
a support structure that supports the mower deck from a mower, the support structure locking a pitch of the mower deck.

12. A mower deck comprising:
a housing that is supported from a mower by a support structure;
one or more cutting units housed within the housing;
a rear roller; and
a suspension by which the rear roller is coupled to the housing, the suspension comprising opposing brackets that are each connected to the housing at a pivot point and oriented rearwardly relative to the housing at a maximum angle less than 90 degrees from horizontal and opposing springs that bias the respective brackets into the maximum angle.

13. The mower deck of claim 12, further comprising:
stops that prevent the opposing brackets from pivoting beyond the maximum angle.

14. The mower deck of claim 12, wherein the opposing springs are configured to enable the opposing brackets to pivot rearwardly and upwardly to a reduced angle when the one or more rear rolling mechanisms encounter a bump.

15. The mower deck of claim 12, wherein the maximum angle is between 35 and 70 degrees.

16. The mower deck of claim 12, wherein the maximum angle is between 55 and 65 degrees.

17. The mower deck of claim 12, wherein a spring rate of the opposing springs is adjustable.

18. A mower deck comprising:
a housing in which one or more cutting units are housed;
a rear rolling mechanism that supports the housing above the ground;
a bracket by which the rear rolling mechanism is coupled to the housing, the bracket being angled rearwardly relative to the housing at a maximum angle less than 90 degrees from horizontal; and
a spring that biases the bracket into the maximum angle and allows the bracket to pivot to a reduced angle when the rear rolling mechanism encounters a bump in the ground.

19. The mower deck of claim 18, wherein the rear rolling mechanism is a rear roller, the bracket is a first bracket that couples a first end of the rear roller to the housing, and the spring is a first spring the biases the first bracket into the maximum angle, the mower deck further comprising:
a second bracket that couples a second end of the rear roller to the housing, the second bracket being angled rearwardly relative to the housing at a maximum angle less than 90 degrees from horizontal; and
a second spring that biases the second bracket into the maximum angle and allows the second bracket to pivot to the reduced angle.

20. The mower deck of claim 18, wherein a spring rate of the spring is adjustable.
